(19) United States
(12) Patent Application Publication
(10) Pub. No.: US 2024/0357575 A1
(43) Pub. Date: Oct. 24, 2024

(54) BEAM PATTERN CONFIGURATION FOR AERIAL COMMUNICATION DEVICE BEAM MANAGEMENT

(71) Applicant: Huawei Technologies Co., Ltd., Shenzhen (CN)

(72) Inventors: Jalal Khamse Ashari, Stittsville (CA); Amine Maaref, Ottawa (CA)

(21) Appl. No.: 18/759,534

(22) Filed: Jun. 28, 2024

Related U.S. Application Data
(63) Continuation of application No. PCT/CN2021/144040, filed on Dec. 31, 2021.

(51) Int. Cl. H04W 72/044

(52) U.S. Cl. CPC H04W 72/046

(57) ABSTRACT

A communication device may receive signaling indicative of an antenna beam direction in which a reference signal may be received by the communication device, and transmit a message responsive to receiving a reference signal from another communication device during monitoring of the antenna beam direction indicated by the received signaling. At least one of the communication devices is an aerial communication device. Considering a different perspective in a wireless communication network, the signaling indicative of antenna beam direction may be transmitted to the communication device, and signaling to cause the other communication device to transmit the reference signal in the antenna beam direction may be transmitted to the other communication device.

### CROSS-REFERENCE TO RELATED APPLICATIONS

This application is a continuation of PCT Application No. PCT/CN2021/144040, entitled “BEAM PATTERN CONFIGURATION FOR AERIAL COMMUNICATION DEVICE BEAM MANAGEMENT,” filed on Dec. 31, 2021, which application is hereby incorporated herein by reference in its entirety.

### TECHNICAL FIELD

The present disclosure relates generally to wireless communications and, in particular embodiments, to beam management for aerial communication devices.

### BACKGROUND

In the current standard for fifth generation wireless communication (5G) new radio (NR), established by 3rd Generation Partnership Project (3GPP), beam sweeping is performed to determine a best transmit-receive beam pair for each user equipment (UE), towards a new cell or transmit and receive point (TRP). Beam sweeping involves sweeping a receive beam through multiple directions at a UE, and attempting to detect synchronization signal blocks (SSBs) that are transmitted in all the directions, by nearby TRPs. For an aerial UE, however, there could be several TRPs that are in a coverage region and can have a line of sight (LoS) path to the UE. For example, up to 16 cells/TRPs can cause high level of interference for an aerial UE at an altitude just above 50 m. This is in contrast to being exposed to just 1 or 2 neighbor TRPs in case of a ground UE. This in turn means that there could be severe interference to and/or from so many terrestrial nodes that share common resources. Moreover, given the number of terrestrial nodes that may be in the coverage of an aerial UE, there can be multiple TRPs that share the same pilot signals or SSBs. The UE may therefore need to perform directional reception in order to reduce interference and to remove ambiguity in detecting SSB signals. Hence, the overhead associated with beam sweeping could be prohibitive for an aerial UE, if SSBs of each TRP in its coverage region are to be measured, especially when the UE is moving fast and beams need to be updated frequently.

Moreover, aerial UEs are at an altitude that is above the height of the terrestrial TRPs, and therefore aerial UEs may receive strong signals over side-lobes of beams that are transmitted from far away TRPs. Side-lobe signals could be stronger than those received over a main-lobe of a nearby TRP. In some environments where TRP beams are customized to serve ground-based (terrestrial) UEs, there might be no main-lobe directly pointing to an aerial UE. Based on a received stronger signal, the aerial UE may connect to a TRP that is farther away from the UE than a nearby TRP, through the side-lobe of a beam that is meant to serve terrestrial UEs. Because of the narrower beam-width and abrupt nulls of a side-lobe, however, such a connection may rapidly fade with a small change in the location of the aerial UE. In this case, the UE may need to frequently hand over from one beam/TRP to another.

Another potential issue with beam identification that involves beam sweeping and SSB detection is with the objective that is followed for beam selection. Particularly, in beam sweeping all directions are examined in order to find the best direction(s) that result in the strongest reference signal received power (RSRP). For an aerial UE, however, a radio link quality can be satisfactory for so many terrestrial nodes that have an LoS path to the aerial UE. Sweeping all the beam directions in order to find the best direction(s) in terms of RSRP therefore may not be a reasonable objective. Moreover, looking for beam directions with the strongest RSRP may result in choosing a number of nearby beams of the same or nearby TRPs that could be spatially correlated. Accordingly, besides its prohibitive overhead, beam sweeping might not result in a selection of beam directions that ensures a robust connection for an aerial UE.

### SUMMARY

Some aspects of the present disclosure relate to reducing overhead associated with beam identification and inter-TRP beam switching.

The present disclosure also encompasses embodiments to potentially enhance connection robustness for an aerial communication device such as an aerial UE, while maintaining a low overhead. For example, in some embodiments connections through side-lobes of beams that are not meant to serve aerial devices are avoided by transmitting reference signals such as SSBs for aerial devices in an on-demand fashion.

A set of connections or beams may be established towards multiple TRPs, while taking aerial node trajectory into account, in order to provide robustness against beam failure by exploiting beam diversity.

Dynamic and seamless switching of UEs from one connection, beam, or TRP (or from one set of connections, beams, or TRPs) to another connection, beam, or TRP (or to another set of connections, beams, or TRPs) at a low overhead is provided in some embodiments.

Embodiments that may help reduce interference from (or to) aerial devices, to (or from) terrestrial devices, are also contemplated.

According to one particular aspect of the present disclosure, a method involves receiving, by a first communication device, signaling indicative of an antenna beam direction in which a reference signal may be received by the first communication device; and transmitting, by the first communication device, a message responsive to receiving a reference signal from a second communication device during monitoring of the antenna beam direction indicated by the received signaling. The first communication device or the second communication device is an aerial communication device.

An apparatus according to another aspect of the present disclosure includes a processor and a non-transitory computer readable storage medium, coupled to the processor, storing programming for execution by the processor. The programming includes instructions to: receive, by a first communication device, signaling indicative of an antenna beam direction in which a reference signal may be received by the first communication device; and transmit, by the first communication device, a message responsive to receiving a reference signal from a second communication device during monitoring of the antenna beam direction indicated by the signaling. The first communication device or the second communication device is an aerial communication device.

A computer program product includes a non-transitory computer readable medium storing programming, and the programming including instructions to: receive, by a first communication device, signaling indicative of an antenna beam direction in which a reference signal may be received by the first communication device; and transmit, by the first communication device, a message responsive to receiving a reference signal from a second communication device during monitoring of the antenna beam direction indicated by the signaling. The first communication device or the second communication device is an aerial communication device, as in other embodiments.

A method according to yet another aspect of the present disclosure involves transmitting, to a first communication device, signaling indicative of an antenna beam direction in which a reference signal may be received by the first communication device; and transmitting, to a second communication device in the wireless communication network, signaling to cause the second communication device to transmit the reference signal in the antenna beam direction. Such a method may be applied, for example, to embodiments in which the first communication device or the second communication device is an aerial communication device.

In another apparatus embodiment in which an apparatus includes a processor and a non-transitory computer readable storage medium, coupled to the processor, storing programming for execution by the processor, the programming may include instructions to: transmit, to a first communication device, signaling indicative of an antenna beam direction in which a reference signal may be received by the first communication device; and transmit, to a second communication device in the wireless communication network, signaling to cause the second communication device to transmit the reference signal in the antenna beam direction. The first communication device or the second communication device may be an aerial communication device.

Programming stored in a non-transitory computer readable medium of a computer program product may include instructions to: transmit, to a first communication device, signaling indicative of an antenna beam direction in which a reference signal may be received by the first communication device; and transmit, to a second communication device in the wireless communication network, signaling to cause the second communication device to transmit the reference signal in the antenna beam direction. The first communication device or the second communication device may be an aerial communication device, as in other embodiments.

Aspects of the present disclosure also encompass an apparatus that includes a processor and a non-transitory computer readable storage medium, coupled to the processor, storing programming for execution by the processor, with the programming including instructions to perform a method disclosed herein.

Similarly, programming stored in a non-transitory computer readable medium of a computer program product may include instructions to perform a method disclosed herein.

### BRIEF DESCRIPTION OF THE DRAWINGS

For a more complete understanding of the present embodiments, and the advantages thereof, reference is now made, by way of example, to the following descriptions taken in conjunction with the accompanying drawings.

FIG. 1 is a simplified schematic illustration of a communication system.

FIG. 2 is a block diagram illustration of the example communication system in FIG. 1.

FIG. 3 illustrates an example electronic device and examples of base stations.

FIG. 4 illustrates units or modules in a device.

FIG. 5 is a block diagram illustrating a coverage area in a wireless communication network.

FIG. 6 is a block diagram illustrating another example of a coverage area in a wireless communication network.

FIG. 7 is a block diagram illustrating a UE moving along a linear trajectory.

FIG. 8 is a block diagram that illustrates updating a receive beam pattern or a subset of active beams as a UE moves along a trajectory.

FIG. 9 is a block diagram illustrating varying inter-beam interference as an aerial UE moves.

FIG. 10 is a block diagram illustrating a trajectory dependent beam pattern that is based on pre-configuration.

FIG. 11 is a flow chart illustrating a method according to one embodiment.

FIG. 12 is a signal flow diagram illustrating how components in a communication network may interact with each other in some embodiments.

### DETAILED DESCRIPTION OF ILLUSTRATIVE EMBODIMENTS

For illustrative purposes, specific example embodiments will now be explained in greater detail in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

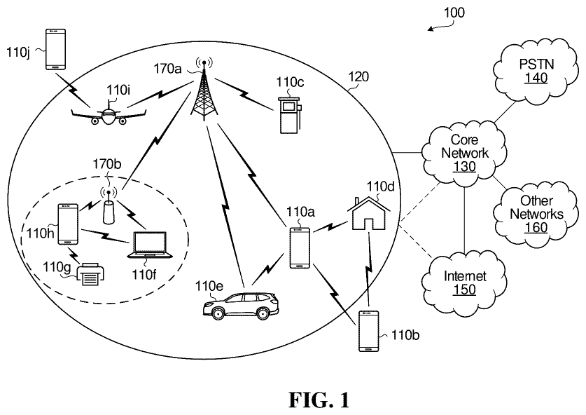

Referring to FIG. 1, as an illustrative example without limitation, a simplified schematic illustration of a communication system is provided. The communication system 100 comprises a radio access network 120. The radio access network 120 may be a next generation (e.g., sixth generation, “6G,” or later) radio access network, or a legacy (e.g., 5G, 4G, 3G or 2G) radio access network. One or more communication electric device (ED) 110a, 110b, 110c, 110d, 110e, 110f, 110g, 110h, 110i, 110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

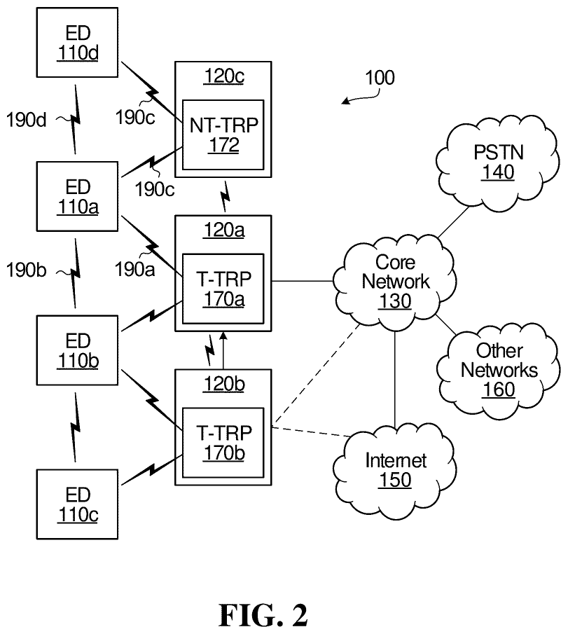

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing and faster physical layer link switching between terrestrial networks and non-terrestrial networks.

The terrestrial communication system and the non-terrestrial communication system could be considered sub-systems of the communication system. In the example shown in FIG. 2, the communication system 100 includes electronic devices (ED) 110a, 110b, 110c, nod (generically referred to as ED 110), radio access networks (RANs) 120a, 120b, a non-terrestrial communication network 120c, a core network 130, a public switched telephone network (PSTN) 140, the Internet 150 and other networks 160. The RANs 120a, 120b include respective base stations (BSs) 170a, 170b, which may be generically referred to as terrestrial transmit and receive points (T-TRPs) 170a, 170b. The non-terrestrial communication network 120c includes an access node 172, which may be generically referred to as a non-terrestrial transmit and receive point (NT-TRP) 172.

Any ED 110 may be alternatively or additionally configured to interface, access, or communicate with any T-TRP 170a, 170b and NT-TRP 172, the Internet 150, the core network 130, the PSTN 140, the other networks 160, or any combination of the preceding. In some examples, the ED 110a may communicate an uplink and/or downlink transmission over a terrestrial air interface 190a with T-TRP 170a. In some examples, the EDs 110a, 110b, 110c and 110d may also communicate directly with one another via one or more sidelink air interfaces 190b. In some examples, the ED 110d may communicate an uplink and/or downlink transmission over a non-terrestrial air interface 190c with NT-TRP 172.

The air interfaces 190a and 190b may use similar communication technology, such as any suitable radio access technology. For example, the communication system 100 may implement one or more channel access methods, such as code division multiple access (CDMA), space division multiple access (SDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The non-terrestrial air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs 110 and one or multiple NT-TRPs 175 for multicast transmission.

The RANs 120a and 120b are in communication with the core network 130 to provide the EDs 110a, 110b, 110c with various services such as voice, data and other services. The RANs 120a and 120b and/or the core network 130 may be in direct or indirect communication with one or more other RANs (not shown), which may or may not be directly served by core network 130 and may, or may not, employ the same radio access technology as RAN 120a, RAN 120b or both. The core network 130 may also serve as a gateway access between (i) the RANs 120a and 120b or the EDs 110a, 110b, 110c or both, and (ii) other networks (such as the PSTN 140, the Internet 150, and the other networks 160). In addition, some or all of the EDs 110a, 110b, 110c may include functionality for communicating with different wireless networks over different wireless links using different wireless technologies and/or protocols. Instead of wireless communication (or in addition thereto), the EDs 110a, 110b, 110c may communicate via wired communication channels to a service provider or switch (not shown) and to the Internet 150. The PSTN 140 may include circuit switched telephone networks for providing plain old telephone service (POTS). The Internet 150 may include a network of computers and subnets (intranets) or both and incorporate protocols, such as Internet Protocol (IP), Transmission Control Protocol (TCP), User Datagram Protocol (UDP). The EDs 110a, 110b, 110c may be multimode devices capable of operation according to multiple radio access technologies and may incorporate multiple transceivers necessary to support such.

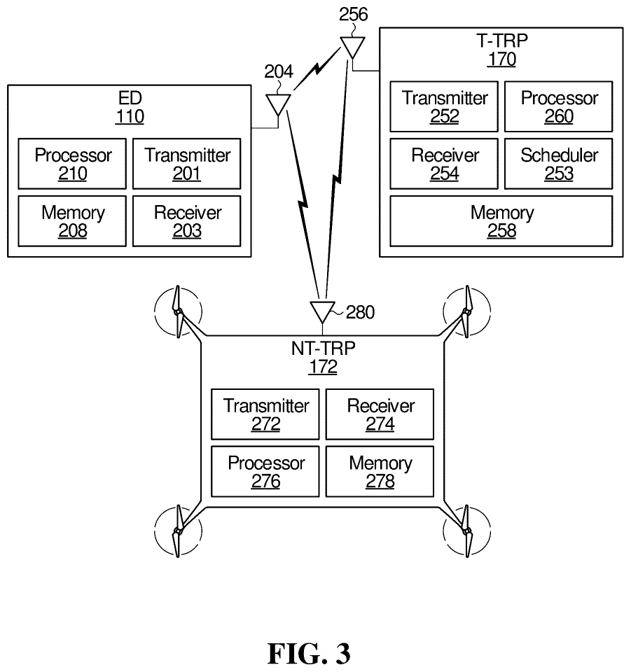

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), Internet of things (IoT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g., communication module, modem, or chip) in the forgoing devices, among other possibilities. Future generation EDs 110 may be referred to using other terms. The base stations 170a and 170b each T-TRPs and will, hereafter, be referred to as T-TRP 170. Also shown in FIG. 3, a NT-TRP will hereafter be referred to as NT-TRP 172. Each ED 110 connected to the T-TRP 170 and/or the NT-TRP 172 can be dynamically or semi-statically turned-on (i.e., established, activated or enabled), turned-off (i.e., released, deactivated or disabled) and/or configured in response to one of more of: connection availability; and connection necessity.

The ED 110 includes a transmitter 201 and a receiver 203 coupled to one or more antennas 204. Only one antenna 204 is illustrated. One, some, or all of the antennas 204 may, alternatively, be panels. The transmitter 201 and the receiver 203 may be integrated, e.g., as a transceiver. The transceiver is configured to modulate data or other content for transmission by the at least one antenna 204 or by a network interface controller (NIC). The transceiver may also be configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by one or more processing unit(s) (e.g., a processor 210). Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache and the like.

The ED 110 may further include one or more input/output devices (not shown) or interfaces (such as a wired interface to the Internet 150 in FIG. 1). The input/output devices permit interaction with a user or other devices in the network. Each input/output device includes any suitable structure for providing information to, or receiving information from, a user, such as through operation as a speaker, a microphone, a keypad, a keyboard, a display or a touch screen, including network interface communications.

The ED 110 includes the processor 210 for performing operations including those operations related to preparing a transmission for uplink transmission to the NT-TRP 172 and/or the T-TRP 170, those operations related to processing downlink transmissions received from the NT-TRP 172 and/or the T-TRP 170, and those operations related to processing sidelink transmission to and from another ED 110. Processing operations related to preparing a transmission for uplink transmission may include operations such as encoding, modulating, transmit beamforming and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g., by detecting and/or decoding the signaling). An example of signaling may be a reference signal transmitted by the NT-TRP 172 and/or by the T-TRP 170. In some embodiments, the processor 210 implements the transmit beamforming and/or the receive beamforming based on the indication of beam direction, e.g., beam angle information (BAI), received from the T-TRP 170. In some embodiments, the processor 210 may perform operations relating to network access (e.g., initial access) and/or downlink synchronization, such as operations relating to detecting a synchronization sequence, decoding and obtaining the system information, etc. In some embodiments, the processor 210 may perform channel estimation, e.g., using a reference signal received from the NT-TRP 172 and/or from the T-TRP 170.

Although not illustrated, the processor 210 may form part of the transmitter 201 and/or part of the receiver 203. Although not illustrated, the memory 208 may form part of the processor 210.

The processor 210, the processing components of the transmitter 201 and the processing components of the receiver 203 may each be implemented by the same or different one or more processors that are configured to execute instructions stored in a memory (e.g., the in memory 208). Alternatively, some or all of the processor 210, the processing components of the transmitter 201 and the processing components of the receiver 203 may each be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a remote radio head, a terrestrial node, a terrestrial network device, a terrestrial base station, a base band unit (BBU), a remote radio unit (RRU), an active antenna unit (AAU), a remote radio head (RRH), a central unit (CU), a distribute unit (DU), a positioning node, among other possibilities. The T-TRP 170 may be a macro BS, a pico BS, a relay node, a donor node, or the like, or combinations thereof. The T-TRP 170 may refer to the forgoing devices or refer to apparatus (e.g., a communication module, a modem or a chip) in the forgoing devices.

In some embodiments, the parts of the T-TRP 170 may be distributed. For example, some of the modules of the T-TRP 170 may be located remote from the equipment that houses antennas 256 for the T-TRP 170, and may be coupled to the equipment that houses antennas 256 over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment that houses antennas 256 of the T-TRP 170. The modules may also be coupled to other T-TRPs. In some embodiments, the T-TRP 170 may actually be a plurality of T-TRPs that are operating together to serve the ED 110, e.g., through the use of coordinated multipoint transmissions.

The T-TRP 170 includes at least one transmitter 252 and at least one receiver 254 coupled to one or more antennas 256. Only one antenna 256 is illustrated. One, some, or all of the antennas 256 may, alternatively, be panels. The transmitter 252 and the receiver 254 may be integrated as a transceiver. The T-TRP 170 further includes a processor 260 for performing operations including those related to: preparing a transmission for downlink transmission to the ED 110; processing an uplink transmission received from the ED 110; preparing a transmission for backhaul transmission to the NT-TRP 172; and processing a transmission received over backhaul from the NT-TRP 172. Processing operations related to preparing a transmission for downlink or backhaul transmission may include operations such as encoding, modulating, precoding (e.g., multiple input multiple output (MIMO) precoding), transmit beamforming and generating symbols for transmission. Processing operations related to processing received transmissions in the uplink or over backhaul may include operations such as receive beamforming, demodulating received symbols and decoding received symbols. The processor 260 may also perform operations relating to network access (e.g., initial access) and/or downlink synchronization, such as generating the content of synchronization signal blocks (SSBs), generating the system information, etc. In some embodiments, the processor 260 also generates an indication of beam direction, e.g., BAI, which may be scheduled for transmission by a scheduler 253. The processor 260 performs other network-side processing operations described herein, such as determining the location of the ED 110, determining where to deploy the NT-TRP 172, etc. In some embodiments, the processor 260 may generate signaling, e.g., to configure one or more parameters of the ED 110 and/or one or more parameters of the NT-TRP 172. Any signaling generated by the processor 260 is sent by the transmitter 252. Note that “signaling,” as used herein, may alternatively be called control signaling. Dynamic signaling may be transmitted in a control channel, e.g., a physical downlink control channel (PDCCH) and static, or semi-static, higher layer signaling may be included in a packet transmitted in a data channel, e.g., in a physical downlink shared channel (PDSCH).

The scheduler 253 may be coupled to the processor 260. The scheduler 253 may be included within, or operated separately from, the T-TRP 170. The scheduler 253 may schedule uplink, downlink and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or part of the receiver 254. Also, although not illustrated, the processor 260 may implement the scheduler 253. Although not illustrated, the memory 258 may form part of the processor 260.

The processor 260, the scheduler 253, the processing components of the transmitter 252 and the processing components of the receiver 254 may each be implemented by the same, or different one of, one or more processors that are configured to execute instructions stored in a memory, e.g., in the memory 258. Alternatively, some or all of the processor 260, the scheduler 253, the processing components of the transmitter 252 and the processing components of the receiver 254 may be implemented using dedicated circuitry, such as a FPGA, a GPU or an ASIC.

Notably, the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110; processing an uplink transmission received from the ED 110; preparing a transmission for backhaul transmission to T-TRP 170; and processing a transmission received over backhaul from the T-TRP 170. Processing operations related to preparing a transmission for downlink or backhaul transmission may include operations such as encoding, modulating, precoding (e.g., MIMO precoding), transmit beamforming and generating symbols for transmission. Processing operations related to processing received transmissions in the uplink or over backhaul may include operations such as receive beamforming, demodulating received signals and decoding received symbols. In some embodiments, the processor 276 implements the transmit beamforming and/or receive beamforming based on beam direction information (e.g., BAI) received from the T-TRP 170. In some embodiments, the processor 276 may generate signaling, e.g., to configure one or more parameters of the ED 110. In some embodiments, the NT-TRP 172 implements physical layer processing but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or part of the receiver 274. Although not illustrated, the memory 278 may form part of the processor 276.

The processor 276, the processing components of the transmitter 272 and the processing components of the receiver 274 may each be implemented by the same or different one or more processors that are configured to execute instructions stored in a memory, e.g., in the memory 278. Alternatively, some or all of the processor 276, the processing components of the transmitter 272 and the processing components of the receiver 274 may be implemented using dedicated circuitry, such as a programmed FPGA, a GPU or an ASIC. In some embodiments, the NT-TRP 172 may actually be a plurality of NT-TRPs that are operating together to serve the ED 110, e.g., through coordinated multipoint transmissions.

The T-TRP 170, the NT-TRP 172, and/or the ED 110 may include other components, but these have been omitted for the sake of clarity.

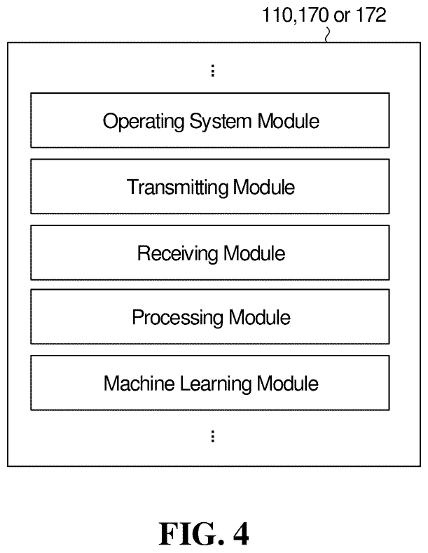

One or more steps of the embodiment methods provided herein may be performed by corresponding units or modules, according to FIG. 4. FIG. 4 illustrates units or modules in a device, such as in the ED 110, in the T-TRP 170 or in the NT-TRP 172. For example, a signal may be transmitted by a transmitting unit or by a transmitting module. A signal may be received by a receiving unit or by a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU or an ASIC. It will be appreciated that where the modules are implemented using software for execution by a processor, for example, the modules may be retrieved by a processor, in whole or part as needed, individually or together for processing, in single or multiple instances, and that the modules themselves may include instructions for further deployment and instantiation.

Additional details regarding the EDs 110, the T-TRP 170 and the NT-TRP 172 are known to those of skill in the art. As such, these details are omitted here.

In some embodiments, reference signals such as SSBs are transmitted to aerial devices in an on-demand fashion, as opposed to “always-on” transmission of such signals for constant beam sweeping. On-demand transmission refers to transmission responsive to an event, trigger, or condition. For example, responsive to a communication device such as a connecting to a network, one or more other communication devices such as TRPs transmit reference signals under network control, or “on-demand” from the network. The term “on-demand” may thus generally express the notion of a feature or service being offered or provided only when needed, whether demand is expressed implicitly, such as by occurrence of an event, trigger, or condition, or explicitly, by a command for example. On-demand might also or instead be considered or referred to as targeted, dedicated, or selective, for example.

This type of more targeted, dedicated, or selective on-demand approach for transmitting reference signals to aerial devices may be useful in reducing complexity, and overhead, of beam sweeping at a network side or a network device such as a TRP. To reduce complexity of beam identification at a UE or other aerial communication device, a receive beam pattern (RBP) may be signaled to, configured at, or otherwise provided to the aerial device to indicate expected receive beam directions, possibly by specifying a sequence of relative shifts or offsets with respect to a reference beam direction with known quasi co-location (QCL). The reference beam direction may be, for example, a direction of a current connection or beam, a direction associated with an initial temporary connection or beam between a communication device and a network, or some other direction that is known at the communication device. An RBP may further indicate communication resources that are to be monitored over each receive beam direction, in certain time-slots for example. The reference signal(s) for any new beam direction(s) are transmitted, in an on-demand fashion consistent with an RBP and over certain communication resources, which can reduce complexity and overhead associated with beam sweeping, search, and identification by limiting the beam search space to only certain directions and resources.

These features, and/or other features disclosed herein, may help avoid having an aerial device access a network through side-lobes, by monitoring only the specific directions and communication resources that are used for on-demand reference signal transmission for example.

Other features, any one or more of which may be provided in some embodiments, include the following, for example:
seamlessly switching or updating an RBP upon detecting one or more events—a trigger to switch an RBP or to update an RBP may be based on any of various events, such as any one or more of the following non-limiting examples: the aerial device reaching one or more points in a trajectory, local measurements meeting a trigger condition, and inter-beam interference measures meeting a trigger condition;
dynamically activating beams, such as subsets of beams within an RBP, to reduce, limit, or otherwise manage the inter-beam interference;
a device-centric approach for beam determination at a communication device, wherein complexity of beam identification is reduced by limiting the beam search into certain directions based on certain pre-configurations.

These and other features are considered in further detail herein, at least below.

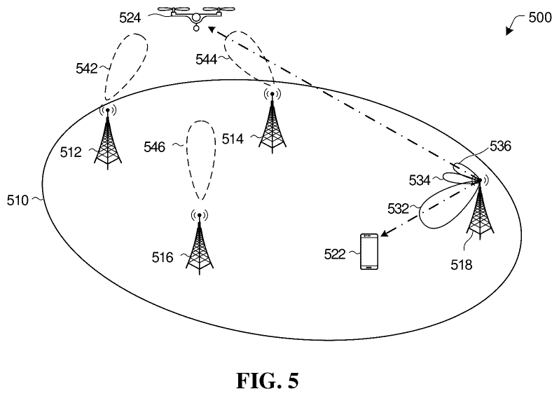

Aerial communication devices may be present only occasionally in a coverage region, and accordingly it is not desirable to constantly sweep reference signals such as SSBs in all directions at elevation angles above the horizon. Avoiding such constant sweeping can help save power, enhance resource utilization, and reduce inter-beam interference and pilot contamination in a network. In the absence of “always-on” reference signals towards the sky, an aerial device can initially establish a connection with a network by detecting side-lobes of the reference signals that are down-tilted or otherwise customized or intended to serve ground-based devices. As an example, see FIG. 5, which is a block diagram illustrating a coverage area 510 in a wireless communication network 500, in which coverage is provided by four TRPs 512, 514, 516, 518.

TRPs may provide access to a communication system for ground-based or terrestrial devices, such as the UE 522, and also or instead for aerial devices, such as the aerial UE 524. In the example shown the aerial UE 524 is a drone. With reference to FIG. 3, an aerial UE is another example of an ED 110, but may be similar in structure to the NT-TRP 172 in the case of an aerial UE. Although an aerial UE is referenced in the description of FIG. 5 and elsewhere herein, features disclosed herein may also or instead be implemented in conjunction with other types of aerial communication devices, including but not limited to aerial TRPs.

The ground-based UE 522 has a main-lobe connection with the TRP 518, as illustrated at 532. Side-lobes of the main-lobe 532 are shown at 534, 536, and an initial connection between the aerial UE 524 and the TRP 518 over the side-lobe 536 is also shown in FIG. 5. Although the initial connection is over the side-lobe 536, the network 500, or in particular a network device such as a control node, one of the TRPs 512, 514, 516, 518 or another device or node in the network, is able to identify whether signals from the aerial UE 524 are received through a side-lobe or a main-lobe, by applying a variety of spatial filters to find the angle of arrival (AoA) of the received signals, for example. The network 500 is also able to calculate or otherwise obtain a rough estimate of the location of the aerial UE 524, so that it can decide which TRP(s) may best serve the aerial UE 524. In the example shown, the TRPs 512, 514, 516 are closer to the aerial UE 524 and are better positioned and selected by the network 500 to serve the aerial UE.

References herein to features that may be provided by a network or operations that may be performed by a network may involve one or more network devices, such as a control node, a TRP, or another device or node in the network. With reference to FIG. 5 as an example, selection of TRPs to serve the aerial UE 524 may be by the TRP 518 to which the aerial UE initially connects, one or more of the other TRPs 512, 514, 516, or a control node (not shown).

Unless otherwise indicated, “connected” and similar terms are used herein to refer to a communication device state after signaling to establish initial access to a network has been carried out. Such signaling may be Layer 3 signaling, for example and may lead a communication device such as a UE to transition from a radio resource control (RRC) Idle or Inactive state to an RRC_CONNECTED state. A UE may also be assigned with a cell identifier (ID), such as a cell radio network temporary ID (C-RNTI), during initial access during initial access. After establishing a connection to the network, a communication device can identify and potentially switch between different beams and possibly different nodes such as TRPs within the same cell or other network coverage area including different cells. Beam identification enables a communication device to establish communications over active antenna beams or an active antenna beam pair with another communication device.

A beam pair link is established to communicate with the network, including during an initial access procedure. A downlink beam pair link for downlink communications with a communication device, for example, includes a transmit beam from a network node such as a TRP and a receive beam at the communication device. Similarly, an uplink beam pair link includes a transmit beam at the communication device and a receive beam at the network node. A transmit/receive beam pair link may also or instead be established for sidelink communications between two UE devices.

Communications between devices may also be referred to herein as being over or through an active antenna beam link or beam pair link. Beam identification may be repeated, active beams or beam pairs may change, and connection establishment may be repeated to connect to a new cell or coverage area, for example.

The TRP 518 initially chosen by the aerial UE 524 is discovered through a side-lobe in this example, and may be located remotely from the newly selected TRPs 512, 514, 516 that are selected by the network 500. The newly selected TRPs 512, 514, 516 may or may not be synchronized with the TRP 518 to which the aerial UE 524 is already synchronized, and in order to synchronize and connect the aerial UE 524 with the newly selected TRPs, the newly selected TRPs can transmit reference signals such as SSBs towards the aerial UE over main-lobes 542, 544, 546.

FIG. 5 thus illustrates, by way of example, switching of an aerial device from an initial, temporary serving side-lobe beam to one or more main-lobe beams established by on-demand reference signal transmission.

Communication resources for on-demand transmission of reference signals may be allocated by the network 500 in a way that minimizes or at least reduces interference with resources that are allocated to serve ground-based UEs such as the UE 522. In the example shown in FIG. 5, the aerial UE 524 can avoid connecting to another side-lobe by monitoring only the resources, which may be UE-specific resources for the aerial UE 524, that are used for on-demand reference signal transmission. It is noted that the on-demand reference signals can be dedicated to a particular UE, such as the aerial UE 524 in the example shown in FIG. 5, by configuring only that UE to detect or receive the reference signal for example, or can be shared and used as a common reference signal by a number of devices that are in the vicinity of each other.

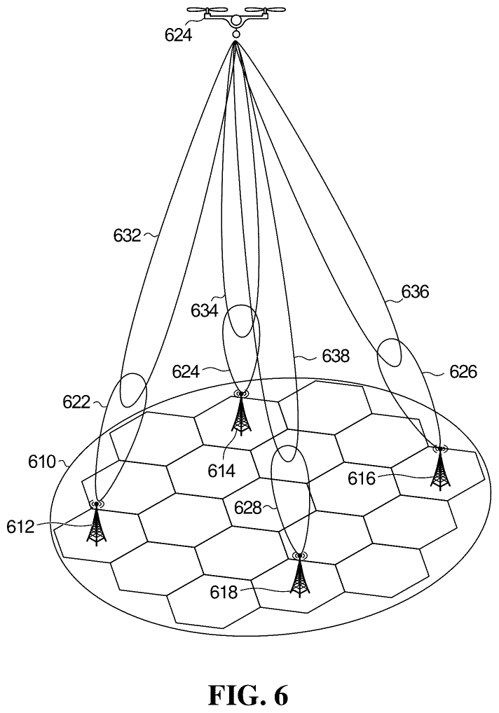

FIG. 6 is a block diagram illustrating another example of a coverage area in a wireless communication network, and may be useful in understanding signaling to indicate an RBP to an aerial UE, and to report selected beams by the UE back to a network. The example in FIG. 6 shows signaling to implement an embodiment in a step-by-step fashion, wherein a network-centric approach is adopted for beam determination. The illustrated example is in the context of an aerial UE 624 attempting to access a wireless communication network in which TRPs 612, 614, 616, 618 provide coverage in a coverage area 610. TRP antenna beams are shown at 622, 624, 626, 628, and UE antenna beams are shown at 632, 634, 636, 638.

Suppose that the UE 624 is initially connected to the network. An initial connection may be, for example, a temporary connection through the side-lobe of a beam that is established at initial access, or connection through a beam that cannot be maintained because of movement and changes in the location of the UE 624. In any case, in this scenario the network needs to establish communications with new TRP(s) for the UE 624 as it is moving along a trajectory. The UE 624 may signal its trajectory to the network, or the trajectory can be estimated by the network based on past UE movements and particularly based on UE locations at prior time instants, for example. Given that the position of TRPs 612, 614, 616, 618 as well as the position and trajectory of the UE 624 are known or available to the network, the network can select a number of candidate TRPs to establish new connections or beams towards the UE. The candidate TRPs may be particularly selected in a way that is expected to maximize or at least increase coverage duration by taking the trajectory of the UE 624 into account, while potentially providing sufficient beam diversity by respecting a minimum angular distance between selected beam directions if more than one beam is selected.

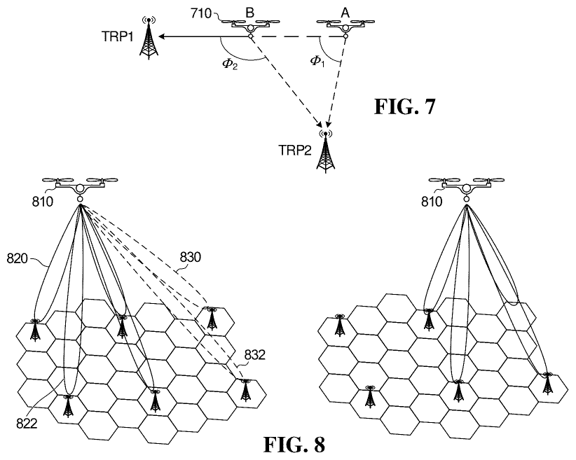

Respecting a minimum angular distance between the selected beam directions may be desirable for not only providing beam diversity, but also potentially enhancing positioning accuracy. For example, consider FIG. 7, which is a block diagram illustrating a UE 710 moving along a linear trajectory from point A to point B. Measurements of the AoA at TRPs in line with the trajectory of the UE, such as at TRP 1 in FIG. 7, do not capture changes in the position of the UE. However, making measurements at multiple TRPs located in different directions with respect to the trajectory of the UE 710, at TRP 1 and TRP 2 in FIG. 7 for example, can help to better track changes in UE position.

Returning to FIG. 6, after choosing candidate TRPs 612, 614, 616, 618, a reference signal is transmitted from each TRP over certain resources towards the user. For example, a control node, one of the TRPs 612, 614, 616, 618, or another network node may send signaling to configure each candidate TRP to transmit a reference signal in one or more beam directions, and using certain communication resources. In order for the UE 624 to be able to detect such on-demand transmitted reference signals, an RBP indicating the selected resources that are used in this example for on-demand reference signal transmissions, and the directions that such signals are expected to be received at the UE, are also transmitted to the UE. Communication resources may be over one or more of time domain, frequency domain, and code domain. Signaling to indicate the RBP to the UE 624 may be a control node, one of the TRPs 612, 614, 616, 618, or another network node, and may or may not be the same network node that transmitted signaling to configure the TRPs to transmit the reference signals.

There is a direct relationship between angular distance of a transmitted beam measured at a TRP with respect to a reference beam direction, and the angular distance of a received beam direction with respect to the same reference beam measured at the user. An RBP may indicate beam directions as a sequence of relative shifts of transmitted beams with respect to a reference beam direction with known QCL, such as the already established beam in this example. Transmitting signaling to the UE 624 to indicate the RBP enables the UE 624 to determine the expected receive beam directions by applying certain shifts with respect to the known reference beam direction. In this way, the UE 624 can attempt to detect reference signals by monitoring in accordance with an RBP. Such monitoring may involve monitoring particular resources over indicated receive beam directions in certain time slots, for example.

After carrying out an SSB detection phase by monitoring in accordance with an RBP, the UE 624 may transmit feedback signaling to the network, to report the detected reference signals along with the RSRP (and/or possibly other measurements) for each of them. Feedback signaling may be transmitted to a control node, one of the TRPs 612, 614, 616, 618, or another network node, which may or may not be the network node that transmitted signaling to configure the TRPs to transmit the reference signals or the network node that transmitted signaling indicating the RBP to the UE. Based on the feedback signaling, different subsets of beams can be activated for communications between the UE 624 and the network via one or more of the TRPs 612, 614, 616, 618.

As a UE moves along its trajectory, it can switch between different subsets of one or more of the active beams within an RBP, or can be configured with an updated RBP. An RBP can be pre-configured for an upcoming point in the trajectory in advance so that the UE can seamlessly switch to an updated RBP, also referred to herein as a new RBP, upon reaching a certain point. Switching to a new RBP may involve repeating a beam identification process for the new RBP, whereas switching between different subsets of one or more active beams likely would not.

Configuring a new RBP or dynamically updating a subset of active beams can be triggered in response to any of various events, such as any one or more of the following: (a) a signal measurement such as an RSRP for an existing beam is lower than a certain threshold—this is an example of a measurement-based trigger condition, (b) the UE reaches certain points or positions in its trajectory, for example an elevation angle of one of the beams becomes lower than a certain threshold, (c) the UE detects a barrier towards one of the TRPs, (d) an inter-beam interference measure is violated—this is an example of an interference measurement-based trigger condition. In the case of any of these events, and/or others in other embodiments, being detected by the UE, the UE may send feedback signaling to the network to trigger an update.

FIG. 8 is a block diagram that illustrates updating an RBP or a subset of active beams as a UE moves along a trajectory. In order to avoid congestion in the drawing, TRPs and separate UE and TRP beams are not labelled. In FIG. 8, the UE 810 moves along a trajectory from its position relative to the TRPs at the left in the drawing to a different position at the right in the drawing. An RBP or a subset of active beams in an RBP are updated as the UE is moved, so that beams 820, 822 are deactivated and beams 830, 832 become active. Signaling to update the RBP or active beams may be received by the UE 810 from a control node, one of the TRPs, or another network node.

Although examples provided above refer to configuring a new RBP or dynamically updating a subset of active beams being triggered in response to any of various events and feedback signaling transmitted by a UE to a network, RBP updated to switch to a new RBP or to a different subset of active beams may be network-initiated or triggered, by a network device detecting a trigger event.

There are several potential benefits associated with transmitting SSBs in an on-demand fashion as disclosed herein, and for indicating expected receive beam directions, and possibly resources, to an aerial device.

For example, one potential benefit is enhancing connection robustness against beam failure for aerial devices. By monitoring only expected receive beam directions and indicated resources, for example, devices can avoid establishing new connections through side-lobes of beams that are not meant to serve aerial devices. Moreover, adopting a RBP which comprises multiple beams over diversified directions towards different TRPs, while taking the device trajectory into account, may also enhance connection robustness. Spatial multiplexing gain, as well as positioning accuracy for each aerial device, are also potentially enhanced by adopting a RBP that ensures sufficient beam diversity.

Another potential benefit is reducing overhead of beam searching and identification by transmitting on-demand reference signals, and by limiting the beam search to certain directions based on an RBP.

On-demand reference signal transmission as disclosed herein may enable power savings, enhance resource utilization, and reduce pilot contamination.

Overhead of inter-TRP beam switching may be reduced by dynamically updating a subset of active beams within a RBP, or by updating an RBP by configuring a new RBP, as a device moves along a trajectory.

An aerial device may cause inter-beam interference with other devices, and that interference may dynamically vary while the aerial device is moving. The reason is that the angular distance between different beams varies as the relative position of a device with respect to other nodes changes. Moreover, the beam-width of a side-lobe, and the interference that is radiated over different directions, also varies as the relative position of a moving device and serving TRPs changes, even though a main-lobe is maintained towards each serving TRP.

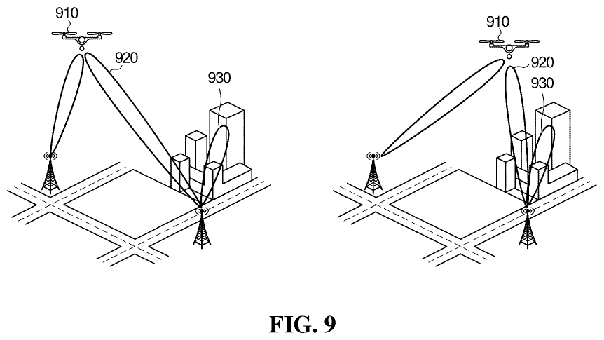

Consider FIG. 9, which is a block diagram illustrating varying inter-beam interference as an aerial UE moves. As shown, as the aerial UE 910 in this example moves from a position at the left in FIG. 9 to a different position at the right in FIG. 9, angular distance between the beams 920, 930 decreases and inter-beam interference increases.

When one specific beam is used to serve an aerial device, it could be interfering with other nodes in a certain zone of a network. Dynamically activating different subset of beams within an RBP may help reduce interference or avoid causing interference over regions of the network that are heavily impacted or heavily loaded. Also, by exploiting the beams within a RBP, the network can opportunistically schedule resources so as to avoid or at least reduce inter-beam interference to and/or from aerial nodes.

For example, reception occasions over different beams within an RBP can be used to measure inter-beam interference at a communication device over various directions. Measurements may be made by and/or reported to the network, and the network then can configure an aerial node with a certain threshold on the level of inter-beam interference imposed by certain TRPs in the downlink direction. The network can also or instead configure aerial devices with a maximum permissible interference that is radiated by the device, towards certain directions for example. An aerial device may then request to switch a subset of active beams, or to update an RBP, if one or more active beams in the current RBP cannot meet one or more inter-beam interference measures or conditions, examples of which are provided at least above.

Inter-beam interference can thus be managed by dynamically activating different RBPs or subsets of beams within an RBP based on certain interference measures. Communication devices may be configured to monitor certain inter-beam interference measures, and send feedback signaling to the network to manage inter-beam interference. Feedback signaling may be or include measurements or indicate that measurements are above thresholds or otherwise outside target ranges, for example.

In some embodiments, a device-centric approach is used to identify beams at a communication device based on certain pre-configurations. This type of approach may be particularly useful for initial access, or in a scenario in which the network does not have an up-to-date estimate of the device trajectory, for example. In the latter scenario, a communication device might transmit a packet relatively infrequently, so the network cannot accurately track device movement.

As an example, suppose that certain reference signals are periodically transmitted over particular resources for aerial devices, and that the aerial devices are pre-configured to monitor those particular resources. To simplify beam identification at the device side, and to provide sufficient beam diversity, the devices may be configured to respect a certain distance in either of the azimuth, δₐ, and/or elevation angle δₑ between the swept beam directions. Based on its trajectory, a device then follows a certain pattern to sweep beam directions, thereby limiting the number of directions that are monitored by the device.

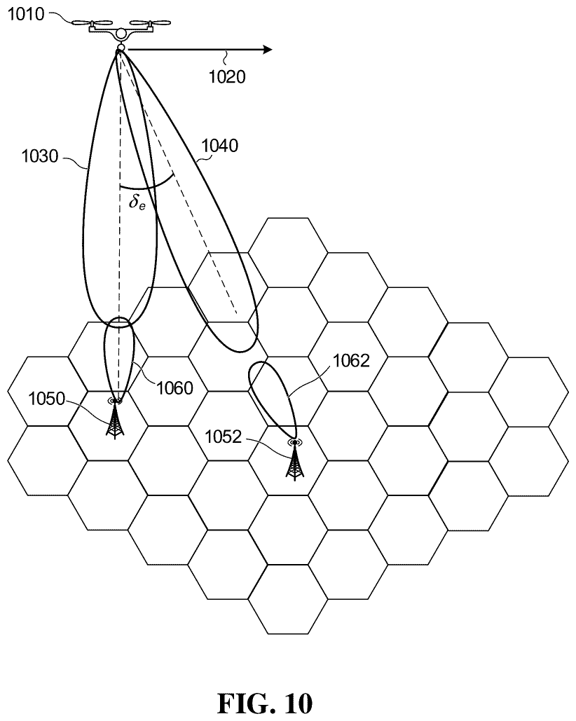

FIG. 10 is a block diagram illustrating a trajectory dependent beam pattern that is based on pre-configuration. The aerial UE 1010 is illustrated as an example of an aerial device, and is moving along a trajectory indicated by the arrow 1020. Two UE beams are shown at 1030, 1040, and two TRPs 1050, 1052 with associated TRP beams 1060, 1062 provide coverage within a coverage area of a wireless communication network.

Particularly, starting from an initial beam direction, the elevation angle of the receive beam direction is shifted by by δₑ in a direction towards the trajectory of the UE 1010, while the azimuth is set in line with the trajectory. If a reference signal is detected with an RSRP greater than a certain threshold, ζ, then the identified receive-beam direction along with the detected SSB are chosen as a candidate beam pair. The UE 1010 then looks into adjacent directions by deviating the azimuth angle from the trajectory by a certain step of ∓δₐ degrees. The UE 1010 keeps looking into other receive beam directions, shifting the elevation angle by δₑ and/or deviating the azimuth angle by ∓δₐ degrees from the user trajectory, until a certain number of beam directions are determined.

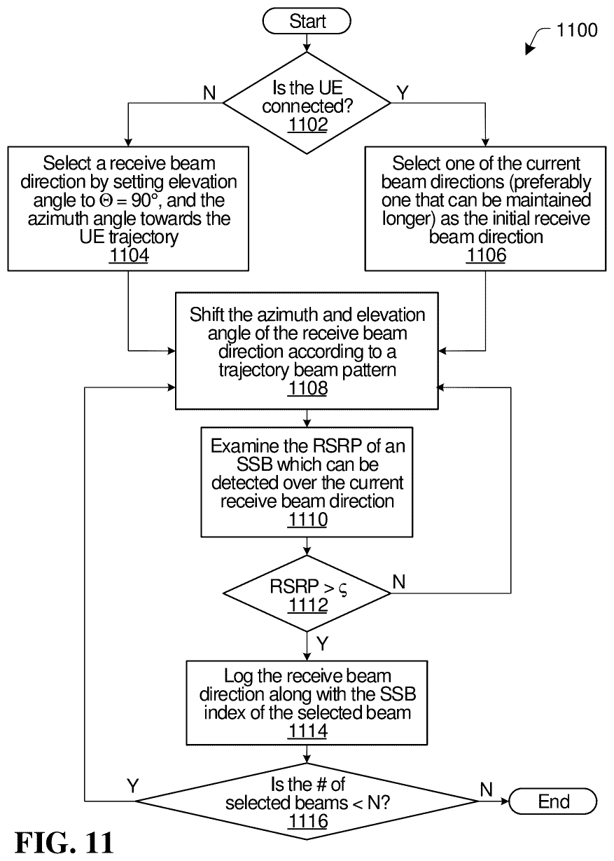

The procedure is summarized in FIG. 11, which is a flow chart illustrating a method according to one embodiment. The example method 1100 involves determining at 1102 whether a communication device, a UE in this example, is connected to the network. An initial receive beam direction is selected at 1104 or 1106, and receive beam angle shifting is shown at 1108. If a reference signal, shown in FIG. 11 by way of example as an SSB, is detected at 1110 and has an RSRP greater than a certain threshold, ζ, as determined at 1112, then the identified receive-beam direction along with the detected SSB are chosen as a candidate beam pair and logged at 1114, by storing a beam direction and SSB information to memory for example. The UE then looks into adjacent directions by deviating the azimuth angle from the trajectory by a certain step of ∓δₐ degrees, and keeps looking into other receive beam directions, shifting the elevation angle by δₑ and/or deviating the azimuth angle by ∓δₐ degrees from the user trajectory at 1108, until a certain number of beam directions (N in FIG. 11 at 1116) are determined.

FIG. 11 is an example. Other embodiments are possible. For example, to select a first receive beam direction, a device may be configured or pre-configured with default beam directions described as a function of device altitude and/or position. Initial receive beam direction may be toward the ground when device altitude is above a certain threshold, for example. Devices may also or instead be configured not to look into certain directions, for example by imposing certain restrictions on beam elevation angle to reduce the likelihood of accessing the network through a far-away TRP.

After its very first access, a device can be provided with certain trajectory-dependent reference beam directions which can be accessed upon reaching certain points in a trajectory. Other beams then can be selected by deviating from the indicated reference beam direction according to a trajectory dependent beam pattern. A device can also or instead be provided with the positions of particular TRPs, along its trajectory, that transmit certain reference beams to aerial devices. Such TRP position information may then be used to find at least one reference beam direction as the device moves along its trajectory.

After a number of beam-pairs are selected by a device, the device may send a message or signaling to the network to indicate the adopted beam pattern to the network while also reporting the detected beams and possibly other measurements such as received signal power, etc., to the network. The receive beam pattern that is used to shift and detect beams can be exploited to remove ambiguity in detected reference signals, so the network can determine the TRPs to which detected reference signals correspond. Based on the candidate beams reported by a device, different subsets of the beams can be activated by the network for communications. For instance, a limited subset of beams can be used for transmission of data packets, while a more comprehensive set can be used for a control channel.

For device-centric beam identification embodiments, parameters such as δₐ, δₑ, and ζ can be configured or pre-configured by the network based on the knowledge of a terrestrial network deployment, and based on such conditions or characteristics as flying altitude of a device. The device can instead choose one or more parameters based on knowledge of altitude and velocity of the device. For example, one or more parameters such as δₐ, δₑ, and ζ can be chosen in a way that at least one of the beams in a beam pattern remains within the coverage of the device after the device is moved over a certain time-interval (T).

A device-centric approach for beam identification may be useful to provide an aerial device with certain pre-configurations in order to reduce complexity of beam search and identification at the device. Such an approach may also be effective in removing ambiguity in detected reference signals that are reported by a device based on relative shifts that are applied following a certain beam pattern.

Features disclosed herein with reference to aerial devices such as aerial UEs, may be useful to facilitate beam identification in the presence of aerial TRPs. Particularly, being employed in an on-demand fashion, aerial TRPs can be configured to transmit on-demand reference signals which are pointed towards certain UEs or towards certain regions of the network. In this example, UEs may be terrestrial UEs or aerial UEs, and can be configured with RBPs or pre-configurations, to monitor certain resources in order to gain access to aerial TRPs. In this way, any or all of overhead of beam sweeping for aerial TRPs, pilot contamination in the network, and overhead of beam searching for UEs can potentially be reduced. Dynamic and on-demand deployment of aerial TRPs may also be supported by establishing connections or beams in an on-demand fashion.

The present disclosure encompasses various embodiments, including method embodiments, apparatus embodiments, and other embodiments such as embodiments related to non-transitory computer readable storage media. Embodiments may incorporate, individually or in combinations, the features disclosed herein.

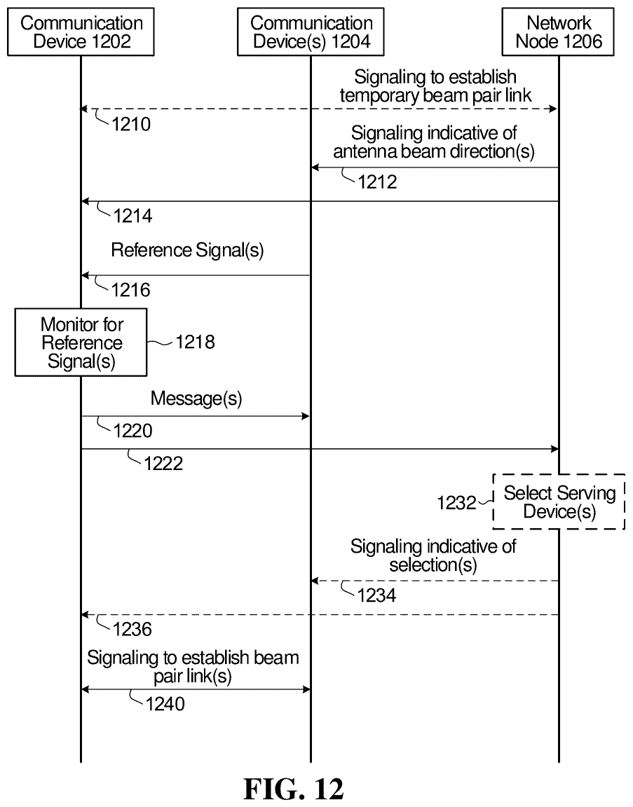

For example, FIG. 12 is a signal flow diagram illustrating how components in a communication network may interact with each other in some embodiments. FIG. 12 illustrates, byway of example only, communication devices 1202, 1204, and a network node 1206. One or more of the communication device 1202 and the communication device(s) 1204 is an aerial communication device. In an embodiment, the communication device 1202 is an aerial UE, 1204 denotes one or more TRPs through which the communication device 1202 may access the communication network, and the network node 1206 may be a TRP or another network device.

According to one embodiment, a method may involve receiving, by a first communication device shown byway of example at 1202, signaling that is indicative of an antenna beam direction in which a reference signal may be received by the first communication device. This is shown in FIG. 12 at 1214. Such signaling may be received from a network node 1206 as shown, which may be a TRP, a control node, or another network node.

From the perspective of the communication device 1202, a method may also involve monitoring of the antenna beam direction(s) indicated by the signaling 1214, for reception a reference signal 1216 from one or more other communication devices 1204. Responsive to receiving a reference signal from a communication device 1204 during monitoring of the antenna beam direction(s) indicated by the signaling received at 1214, the communication device 1202 may transmit one or more messages 1220, 1222. A transmitted message may be or include a measurement report for different transmit-receive beam pairs with different communication devices 1204, or a request to establish a new beam pair link or a new connection, for example.

Feedback or feedback signaling to the network is described herein at least above, to report detected reference signals and possibly RSRP and/or other measurements for each of them, and are examples of a message that may be transmitted by a communication device 1202 at 1220 and/or 1222 as a measurement report. A message that includes a request to establish a new beam pair link or a new connection may be transmitted by the communication device 1202 at 1220 and/or 1222, as a random access preamble message through a physical random access channel (PRACH) for example, under certain conditions such as when a current connection is not stable. PRACH and a random access preamble message are illustrative examples. Transmission and reception of messages may involve, for example, contention-free or contention-based PRACH, grant-free transmission, or other messaging approaches.

As described at least above, feedback signaling may be transmitted to a control node, a TRP, or another network node. A network node to which feedback signaling, or more generally a message 1220, 1222, is transmitted may or may not be the network node 1206 that transmitted signaling 1212 to configure one or more communication devices 1204 to transmit reference signals or the network node that transmitted signaling 1214 indicating antenna beam direction(s) to the UE.

One or more communication devices 1204 may be selected as serving devices to serve the communication device 1202. Selection of the serving device(s) may be by the communication device 1202, in which case one or more beam link pair(s) may be established at 1240 responsive to one or more messages 1220 transmitted by the communication device 1202 to one or more communication devices 1204. Another possible option involves the network node 1206 selecting one or more serving devices and transmitting signaling indicative of the selection(s) to either or both of selected communication device(s) 1204 and the communication device 1202. Such signaling is received by the communication device 1202 and/or one or more communication devices 1204, and responsive to receiving such signaling one or more beam pair links are established at 1240, to enable the communication device 1202 to communicate with one or more of the communication devices 1204 and access the network.

In some embodiments, the signaling 1214 is indicative of a receive beam pattern that indicates antenna beam directions in which one or more reference signals may be received by the communication device 1204. A receive beam pattern may indicate antenna beam directions as a sequence of relative shifts with respect to a reference beam direction. More generally, an antenna beam direction may be indicated as a relative shift with respect to a reference beam direction, regardless of whether the antenna beam direction is or is not part of a receive beam pattern.

A receive beam pattern may also indicate communication resources that are to be monitored over each of the antenna beam directions.

Initial or temporary side-lobe connections are discussed at least above, with reference to FIG. 5 for example. More generally, a method may involve establishing, by the communication device 1202, a first beam pair link with a wireless communication network as shown at 1210. Such a beam pair link may be over a side-lobe, but whether a connection or beam pair link is over a side-lobe may be transparent to the communication device 1202. A network node such as the network node 1206 in the example shown in FIG. 12 may be able to identify whether signals from a communication device are received through a side-lobe or a main-lobe. In any case, an initial or temporary “first” beam pair link may be established at 1210 responsive to the communication device 1202 receiving a common synchronization reference signal, such as an SSB, that is not dedicated only to or otherwise specific to the communication device 1202. A common synchronization reference signal is not shown in FIG. 12 so as to avoid further congestion in the drawing.

In the example shown in FIG. 12, receiving the signaling 1214 by the communication device 1202 involves receiving the signaling subsequent to establishing the first beam pair link with the wireless communication network. The network node 1206 may calculate or otherwise obtain a rough estimate of location of the communication device 1202, and determine which communication device(s) 1204, illustratively TRP(s), may best serve the communication device 1202. For example, the communication device(s) 1204 may be closer to the communication device 1202 than the network node 1206, and be better positioned and selected by the network node to serve the communication device 1202. The signaling 1212 is transmitted to the communication device(s) 1204 to cause the communication device(s) 1204 to transmit the reference signal(s) 1216 in an on-demand fashion.

In embodiments that involve indication of antenna beam direction(s) in terms of relative shift(s) with respect to a reference beam direction, the reference beam direction may be the direction of a initial or temporary first beam pair link.

A receive beam pattern need not be permanent, and in some embodiments a method may involve updating the receive beam pattern or a subset of active antenna beams from the antenna beam directions indicated by the receive beam pattern, responsive to detecting an event. Examples of events include an aerial communication device reaching a point in a trajectory, a signal measurement meeting a trigger condition, detection of a barrier between the first communication device and the second communication device, and an inter-beam interference measure meeting a trigger condition. A receive beam pattern, antenna beam direction, or active antenna beam update may be triggered by or responsive to detecting any one or more of these example events, or possibly others.

In some embodiments, a method involves updating a receive beam pattern, one or more antenna beam direction, or a subset of active antenna beams from antenna beam directions indicated by a receive beam pattern responsive to a current active antenna beam not meeting an inter-beam interference condition. An inter-beam interference condition may be or include, for example, any one or more of: a threshold on a level of inter-beam interference imposed by the a communication device 1204, a maximum permissible interference that is radiated by the communication device 1202, and a maximum permissible interference that is radiated by the communication device 1202 towards certain directions.

On-demand reference signals may be provided in some embodiments, but need not be implemented in every embodiment. With continued reference to FIG. 12, the antenna beam direction(s) indicated by the signaling 1214 may be or include a direction in which reference signals are periodically transmitted in a wireless communication network, at 1216. Transmitting a message at 1220, 1222 may then be responsive to the communication device 1202 receiving a periodically transmitted reference signal 1216 from one or more of the communication devices 1204.

In embodiments that involve periodically transmitted reference signals, a method may involve the communication device 1202 monitoring the antenna beam direction(s) in which reference signals are periodically transmitted, in accordance with a distance in either or both of azimuth, δₐ and elevation angle δₑ between swept antenna beam directions.

An antenna beam direction indicated by received signaling 1214 may be or include an initial beam search direction for the communication device 1202. That initial beam search direction may be defined as a function of altitude of the communication device 1202, for example.

Periodic reference signal transmissions may be or include dedicated reference signal transmissions that are dedicated to serve one communication device or a group of communication devices that are within a certain location for example. Configuration parameters may include, for example, one or more of beam direction, periodicity, and time-frequency resources, and/or possibly others, and may be signaled to a communication device or group of communication devices. Such parameters may be transmitted to and received by one or more communication devices in common or device-specific signaling, such as radio resource control (RRC) signaling for example. Considering FIG. 12 in this context, the signaling at 1212 and/or 1214 may be indicative of not only a beam direction, but also any one or more of: periodicity and communication resources over which reference signals 1216 are periodically transmitted.

Whether transmitted periodically or on-demand, the reference signaling 1216 may be dedicated to serve the communication device 1202 or a group of communication devices that includes the communication device 1202.

The discussion of FIG. 12 above is primarily from the perspective of the communication device 1202. Embodiments disclosed herein may also involve other components, and therefore it may be useful to consider the example in FIG. 12 from the perspectives of those components as well.

In FIG. 12, the one or more communication devices 1204 transmit reference signals. From the perspective of a communication device 1204, a method may involve receiving signaling 1212 that is indicative of an antenna beam direction in which a reference signal is to be transmitted by the device. A method may also involve transmitting the reference signal 1216 over the antenna beam direction, and receiving a message 1220. The message 1220 may be received by a communication device 1204 responsive to selection of the that communication device for communicating with the communication device 1202, after receipt of the reference signal 1216 by the communication device 1202. The communication device 1202 itself, or another device or component such as the network node 1206, may select a communication device 1204 as a serving device for communicating with the communication device 1202 in order to enable the communication device 1202 to access the network.

Features that are discussed above with reference to the communication device 1202 may have counterparts, or may otherwise apply, to a communication device 1204. For example, a communication device 1204 may transmit a reference signal 1216 that is received by the communication device 1202, and a message 1220 that is transmitted by the communication device 1202 may be received by a communication device 1204. Features of reference signals and/or messages may apply regardless of whether reference signals or messages are being transmitted or received. In short, features that are discussed herein, even in the context of a particular communication device, network node, or embodiment, may also or instead be applied to other embodiments.

Methods related to a reference signal transmitter may include any one or more of the following features, for example, which are also discussed elsewhere herein:
the antenna beam direction is indicated in the signaling 1212 as a relative shift with respect to a reference beam direction;
   the signaling 1212 further indicates communication resources in which a reference signal 1216 is to be transmitted over the antenna beam direction;
the receiving at 1220 involves receiving a message subsequent to the communication device 1202 establishing a first beam pair link with the network at 1210, responsive to receiving a common synchronization reference signal that is not specific to the communication device 1202;
the reference beam direction with respect to which the antenna beam direction may be indicated as a relative shift is the direction of the first beam pair link;
the signaling 1212 is transmitted to the communication device 1204 responsive to the second communication device detecting an event to trigger an update to a receive beam pattern of the communication device 1204 or a subset of active antenna beams from the receive beam pattern;
a network node or a communication device other than the second communication device may detect an event to trigger an update—for example, it is possible that the first communication device may detect an event and send a feedback message or measurement report to trigger an update;
the event is or includes any one or more of: the aerial communication device reaching a point in a trajectory, a signal measurement meeting a trigger condition, detection of a barrier between the communication device 1202 and a communication device 1204, and an inter-beam interference measure meeting a trigger condition;
the signaling 1212 is transmitted to a communication device 1204 responsive to a current active antenna beam of the communication device 1202 not meeting an inter-beam interference condition that triggers an update to a receive beam pattern of the communication device 1202 or a subset of active antenna beams from the receive beam pattern;
the inter-beam interference condition is or includes any one or more of: a threshold on a level of inter-beam interference imposed by a communication device 1204, a maximum permissible interference that is radiated by the communication device 1202, and a maximum permissible interference that is radiated by the communication device 1202 towards certain directions;
transmitting a reference signal 1216 involves periodically transmitting the reference signal;
receiving a message at 1220 involves receiving the message responsive to selection of a communication device 1204 after receipt of the periodically transmitted reference signal by the communication device 1202;
the signaling 1212 is further indicative of any one or more of: periodicity and communication resources over which the reference signal 1216 is to be periodically transmitted by a communication device 1204;
the reference signaling is dedicated to serve the communication device 1202 or a group of communication devices that includes the communication device 1202;
a message 1220 and/or 1222 is or includes a measurement report for different transmit-receive beam pairs, or a request to establish a new beam pair link or a new connection.

Turning now to the network node 1206, which is illustrative of a node that may be involved overall management or control of aspects of beam management as disclosed herein, a method may involve transmitting, to the communication device 1202, signaling 1214 indicative of an antenna beam direction in which a reference signal may be received by that communication device, and transmitting, to a communication device 1204, signaling 1212 to cause that communication device 1204 to transmit the reference signal 1216 in the antenna beam direction.

Other features that are discussed herein may also or instead be applied to such a method.

For example, considering a control node or other network node such as a TRP, which may or may not be directly involved in transmitting or receiving reference signals, method embodiments may include any one or more of the following features, independently or in any of various combinations:
the signaling 1214 indicative of an antenna beam direction is indicative of a receive beam pattern that indicates antenna beam directions in which one or more reference signals may be received by the communication device 1202;
transmitting signaling 1212 to a communication device 1204 may involve transmitting, to multiple communication devices 1204, signaling 1212 to cause those communication devices to transmit reference signals 1216 in the antenna beam directions indicated by the receive beam pattern;
antenna beam directions are indicated as relative shifts with respect to a reference beam direction;
a receive beam pattern and the signaling 1212 transmitted to communication devices 1204 indicate communication resources in which the reference signals 1216 are to be transmitted over each of the antenna beam directions;
the signaling 1214 indicative of the antenna beam direction and the signaling 1214 to cause the communication device(s) 1204 to transmit the reference signal(s) 1216 are transmitted responsive to the communication device 1202 establishing a first beam pair link with the network at 1210, subsequent to receiving a common synchronization reference signal that is not specific to the communication device 1202;
the reference beam direction with respect to which antenna beam directions may be indicated as relative shifts is the direction of the first beam pair link;
transmitting, to the communication device 1202, signaling to update a receive beam pattern or a subset of active antenna beams from the antenna beam directions indicated by a receive beam pattern, responsive to detection of an event;
the event is or includes any one or more of: the aerial communication device reaching a point in a trajectory, a signal measurement meeting a trigger condition, detection of a barrier between the communication device 1202 and a communication device 1204, and an inter-beam interference measure meeting a trigger condition;
transmitting, to the communication device 1202, signaling to update a receive beam pattern or a subset of active antenna beams from antenna beam directions indicated by a receive beam pattern, responsive to a current active antenna beam not meeting an inter-beam interference condition;
the inter-beam interference condition is or includes any one or more of: a threshold on a level of inter-beam interference imposed by a communication device 1204, a maximum permissible interference that is radiated by the communication device 1202, and a maximum permissible interference that is radiated by the communication device 1202 towards certain directions;
an antenna beam direction is or includes a direction in which a reference signal 1216 is to be periodically transmitted;
receiving, from the communication device 1202, a message 1222 responsive to the communication device receiving the periodically transmitted reference signal 1216;
the antenna beam direction is or includes an initial beam search direction defined as a function of altitude of the communication device 1202;
the signaling 1214 indicative of the antenna beam direction is further indicative of any one or more of: periodicity and communication resources over which the reference signal 1216 is to be periodically transmitted;
receiving, from the communication device 1202, the message 1222 responsive to the communication device receiving a reference signal 1216;
the message 1222 is or includes a measurement report for different transmit-receive beam pairs, or a request to establish a new beam pair link or a new connection;
the reference signaling 1216 is dedicated to serve the communication device 1202 or a group of communication devices that includes the communication device 1202.

Other features disclosed herein may also or instead be provided in other embodiments.

Various examples of communication systems and communication devices in which features disclosed herein may be implemented are provided at least above. Computer program product embodiments are also contemplated.

An apparatus may include a processor and a non-transitory computer readable storage medium, coupled to the processor, storing programming for execution by the processor. In FIG. 3, for example, the processors 210, 260, 276 may each be or include one or more processors, and each memory 208, 258, 278 is an example of a non-transitory computer readable storage medium, in an ED 110 and a TRP 170, 172. A non-transitory computer readable storage medium need not necessarily be provided only in combination with a processor, and may be provided separately in a computer program product, for example.

From the perspective of the communication device 1202 in FIG. 12 as an illustrative example, programming stored in or on a non-transitory computer readable storage medium may include instructions to, or to cause a processor to, receive signaling 1214 indicative of an antenna beam direction in which a reference signal 1216 may be received by the communication device; and transmit, by the communication device, a message 1220 and/or 1222 responsive to receiving a reference signal 1216 from a communication device 1204 during monitoring 1218 of the antenna beam direction indicated by the signaling.

An apparatus may include any one or more of the following features, for example, which are also discussed elsewhere herein:
the received signaling 1214 is indicative of a receive beam pattern that indicates antenna beam directions in which one or more reference signals may be received by the communication device 1202;
the receive beam pattern indicates the antenna beam directions as a sequence of relative shifts with respect to a reference beam direction;
the receive beam pattern further indicates communication resources that are to be monitored over each of the antenna beam directions;
the programming further includes instructions to, or to cause a processor to, establish, by the communication device 1202, a first beam pair link at 1210 with the network, responsive to receiving a common synchronization reference signal that is not specific to the communication device 1202;
the signaling 1214 is received subsequent to establishing the first beam pair link with the network at 1210;
the reference beam direction with respect to which the receive beam pattern indicates the antenna beam directions as a sequence of relative shifts is the direction of the first beam pair link;
the programming further includes instructions to, or to cause a processor to, update the receive beam pattern or a subset of active antenna beams from the antenna beam directions indicated by the receive beam pattern, responsive to detecting an event;
the event is or includes any one or more of: the aerial communication device reaching a point in a trajectory, a signal measurement meeting a trigger condition, detection of a barrier between the communication device 1202 and a communication device 1204, and an inter-beam interference measure meeting a trigger condition;
the programming further includes instructions to, or to cause a processor to, update the receive beam pattern or a subset of active antenna beams from the antenna beam directions indicated by the receive beam pattern, responsive to a current active antenna beam not meeting an inter-beam interference condition;
the inter-beam interference condition is or includes any one or more of: a threshold on a level of inter-beam interference imposed by a communication device 1204, a maximum permissible interference that is radiated by the communication device 1202, and a maximum permissible interference that is radiated by the communication device 1202 towards certain directions;
the antenna beam direction is or includes a direction in which reference signals are periodically transmitted in the network;
the message 1220 and/or 1222 is transmitted responsive to receiving a periodically transmitted reference signal 1216 from a communication device 1204;
the programming further includes instructions to, or to cause a processor to, monitor the antenna beam direction in which the reference signals 1216 are periodically transmitted in accordance with a distance in either or both of azimuth, δₐ and elevation angle δₑ between swept antenna beam directions;
the antenna beam direction indicated by the received signaling 1214 is or includes an initial beam search direction defined as a function of altitude of the communication device 1202;
the signaling 1214 is further indicative of any one or more of: periodicity and communication resources over which the reference signals 1216 are periodically transmitted;
the reference signaling 1216 is dedicated to serve the communication device 1202 or a group of communication devices that includes the communication device 1202;
   the transmitted message 1220 and/or 1222 is or includes a measurement report for different transmit-receive beam pairs, or a request to establish a new beam pair link or a new connection.

From the perspective of a communication device 1204 in FIG. 12, programming for execution by a processor may include instructions to, or to cause the processor to: receive, by a communication device 1204, signaling 1212 indicative of an antenna beam direction in which a reference signal 1216 is to be transmitted. The programming may also include instructions to, or to cause the processor to, transmit the reference signal 1216 by the communication device 1204 over the antenna beam direction; and receive, by the communication device, a message 1220 responsive to selection of the communication device for communicating with the communication device 1202, after receipt of the reference signal 1216 by the communication device 1202.

Any of the following features may be implemented, alone or in any of various combinations, in conjunction with a communication device that is involved in transmitting a reference signal:
the antenna beam direction is indicated as a relative shift with respect to a reference beam direction;
the signaling 1212 further indicates communication resources in which the reference signal 1216 is to be transmitted over the antenna beam direction;
the programming includes instructions to, or to cause the processor to, receive the message 1220, by the communication device 1204, subsequent to the communication device 1202 establishing a first beam pair link with the network at 1210 responsive to receiving a common synchronization reference signal that is not specific to the communication device 1202; the reference beam direction, with respect to which the antenna beam direction is indicated as a relative shift, is the direction of the first beam pair link;
the signaling 1212 is transmitted to a communication device 1204 responsive to the communication device 1202 detecting an event to trigger an update to a receive beam pattern of the communication device 1202 or a subset of active antenna beams from the receive beam pattern;
a network node or a communication device other than the communication device 1202 may detect an event to trigger an update—for example, it is possible that the communication device 1204 may detect an event and send a feedback message or measurement report to trigger an update;
the event is or includes any one or more of: the aerial communication device reaching a point in a trajectory, a signal measurement meeting a trigger condition, detection of a barrier between the communication device 1202 and a communication device 1204, and an inter-beam interference measure meeting a trigger condition;
the signaling 1212 is transmitted to the communication device 1204 responsive to a current active antenna beam of the communication device 1202 not meeting an inter-beam interference condition that triggers an update to a receive beam pattern of the communication device 1202 or a subset of active antenna beams from the receive beam pattern;
the inter-beam interference condition is or includes any one or more of: a threshold on a level of inter-beam interference imposed by the communication device 1204, a maximum permissible interference that is radiated by the communication device 1202, and a maximum permissible interference that is radiated by the communication device 1202 towards certain directions;
   the programming further includes instructions to, or to cause the processor to, periodically transmit the reference signal 1216;
the programming further includes instructions to, or to cause the processor to, receive the message 1220, by a communication device 1204, responsive to selection of the communication device 1204 after receipt of the periodically transmitted reference signal 1216 by the communication device 1202;
the signaling 1212 is further indicative of any one or more of: periodicity and communication resources over which the reference signal 1216 is to be periodically transmitted; the reference signaling 1216 is dedicated to serve the communication device 1202 or a group of communication devices that includes the communication device 1202;
the message 1220 is or includes a measurement report for different transmit-receive beam pairs, or a request to establish a new beam pair link or a new connection.

Consider now an apparatus in the context of a network node such as 1206 in FIG. 12. Such an apparatus may include a processor and a non-transitory computer readable storage medium storing programming, for execution by the processor, that includes instructions to transmit, to the communication device 1202, signaling 1214 indicative of an antenna beam direction in which a reference signal 1216 may be received by that communication device, and to transmit, to a communication device 1204, signaling 1212 to cause the communication device 1204 to transmit the reference signal in the antenna beam direction.

Any one or more of the following may be implemented in conjunction with such an apparatus:
the signaling 1214 indicative of an antenna beam direction is indicative of a receive beam pattern that indicates antenna beam directions in which one or more reference signals 1216 may be received by the communication device 1202;
the programming includes instructions to, or to cause the processor to, transmit signaling 1212 to multiple communication devices 1204, to cause the communication devices to transmit the reference signals 1216 in the antenna beam directions indicated by the receive beam pattern;
   the antenna beam directions are indicated as relative shifts with respect to a reference beam direction;
the receive beam pattern and the signaling 1212 transmitted to the communication devices 1204 indicate communication resources in which the reference signals 1216 are to be transmitted over each of the antenna beam directions;
the programming includes instructions to, or to cause the processor to, transmit the signaling 1214 indicative of the antenna beam direction and the signaling 1212 to cause a communication device 1204 to transmit a reference signal 1216 responsive to the communication device 1202 establishing a first beam pair link with the network at 1210 subsequent to receiving a common synchronization reference signal that is not specific to the first communication device 1202;
the reference beam direction with respect to which the antenna beam directions are indicated as relative shifts is the direction of the first beam pair link;
the programming further includes instructions to, or to cause the processor to, transmit, to the communication device 1202, signaling to update the receive beam pattern or a subset of active antenna beams from the antenna beam directions indicated by the receive beam pattern, responsive to detection of an event;
the event is or includes any one or more of: the aerial communication device reaching a point in a trajectory, a signal measurement meeting a trigger condition, detection of a barrier between the communication device 1202 and a communication device 1204, and an inter-beam interference measure meeting a trigger condition;
the programming further includes instructions to, or to cause the processor to, transmit, to the communication device 1202, signaling to update the receive beam pattern or a subset of active antenna beams from the antenna beam directions indicated by the receive beam pattern, responsive to a current active antenna beam not meeting an inter-beam interference condition;
the inter-beam interference condition is or includes any one or more of: a threshold on a level of inter-beam interference imposed by a communication device 1204, a maximum permissible interference that is radiated by the communication device 1202, and a maximum permissible interference that is radiated by the communication device 1202 towards certain directions;
the antenna beam direction is or includes a direction in which the reference signal 1216 is to be periodically transmitted;
the programming includes instructions to, or to cause the processor to, receive, from the communication device 1202, a message 1222 responsive to the communication device 1202 receiving the periodically transmitted reference signal;
the antenna beam direction is or includes an initial beam search direction defined as a function of altitude of the communication device 1202;
the signaling 1214 indicative of the antenna beam direction is further indicative of any one or more of: periodicity and communication resources over which the reference signal 1216 is to be periodically transmitted;
the message 1222 is or includes a measurement report for different transmit-receive beam pairs, or a request to establish a new beam pair link or a new connection;
the reference signal 1216 is dedicated to serve the communication device 1202 or a group of communication devices that includes the communication device 1202.

Other features, including those disclosed herein in the context of method embodiments, may also or instead be implemented in apparatus or computer program product embodiments.

Some embodiments disclosed herein introduce receive beam patterns for aerial device beam management. Signaling may be transmitted to a communication device to indicate the RBP to the device, and the RBP may indicate receive beam directions and communication resources that should be monitored in certain time slots, for example, to reduce complexity of beam identification for devices. An RBP may use relative indication of the beam directions with respect to a beam with known QCL.

Reference signals such as SSBs may be transmitted in an on-demand fashion.

Subsets of active beams, or an RBP, may be dynamically switched or updated. An update may be triggered upon a device reaching certain points in its trajectory, or responsive to other events.

Inter-beam interference is monitored in some embodiments, so as to reduce interference to and/or from aerial nodes.

A device-centric approach may reduce complexity of beam identification at the device by adopting a trajectory dependent beam pattern based on certain configurations or pre-configurations. For example, certain resources to be monitored by aerial devices may be pre-configured at the devices. In some embodiments, elevation angle of a first beam search direction is configured based on device altitude. Requirements on respecting a certain distance in either of the azimuth/elevation angle domains between the swept beam directions may also or instead be established.

What has been described is merely illustrative of the application of principles of embodiments of the present disclosure. Other arrangements and methods can be implemented by those skilled in the art.

For example, although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the Figures or all of the portions schematically shown in the Figures. Moreover, selected features of one example embodiment could be combined with selected features of other example embodiments.

The present disclosure refers primarily to SSBs as examples of reference signals. However, it should be appreciated that features disclosed herein may also or instead be applied to other types of reference signals that are involved in network access, such as different channel state information reference signals (CSI-RSs). For example, different CSI-RSs can be defined for various purposes, such as link beam management, CSI measurement, tracking reference signals, etc., and such RSs can be either specific to a particular communication device or common and not specific to any particular communication device.

While this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

Although aspects of the present invention have been described with reference to specific features and embodiments thereof, various modifications and combinations can be made thereto without departing from the invention. The description and drawings are, accordingly, to be regarded simply as an illustration of some embodiments of the invention as defined by the appended claims, and are contemplated to cover any and all modifications, variations, combinations or equivalents that fall within the scope of the present invention. Therefore, although embodiments and potential advantages have been described in detail, various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

In addition, although described primarily in the context of methods and apparatus, other implementations are also contemplated, as instructions stored on a non-transitory computer-readable medium, for example. Such media could store programming or instructions to perform any of various methods consistent with the present disclosure.

Moreover, any module, component, or device exemplified herein that executes instructions may include or otherwise have access to a non-transitory computer readable or processor readable storage medium or media for storage of information, such as computer readable or processor readable instructions, data structures, program modules, and/or other data. A non-exhaustive list of examples of non-transitory computer readable or processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and nonremovable media implemented in any method or technology, random-access memory (RAM), read-only memory (ROM), electrically erasable programmable read-only memory (EEPROM), flash memory or other memory technology. Any such non-transitory computer readable or processor readable storage media may be part of a device or accessible or connectable thereto. Any application or module herein described may be implemented using instructions that are readable and executable by a computer or processor may be stored or otherwise held by such non-transitory computer readable or processor readable storage media.

What is claimed is:

1. A method comprising:
receiving, by a first communication device, signaling indicative of an antenna beam direction in which a reference signal may be received by the first communication device;
transmitting, by the first communication device, a message responsive to receiving a reference signal from a second communication device during monitoring of the antenna beam direction indicated by the received signaling,
the first communication device or the second communication device comprising an aerial communication device.

2. The method of claim 1, wherein the received signaling is indicative of a receive beam pattern that indicates antenna beam directions in which one or more reference signals may be received by the first communication device.

3. The method of claim 2, wherein the receive beam pattern indicates the antenna beam directions as a sequence of relative shifts with respect to a reference beam direction.

4. The method of claim 2, wherein the receive beam pattern further indicates communication resources that are to be monitored over each of the antenna beam directions.

5. The method of claim 1, further comprising:
establishing, by the first communication device, a first beam pair link with a wireless communication network responsive to receiving a common synchronization reference signal that is not specific to the first communication device,
wherein receiving the signaling comprises receiving the signaling subsequent to establishing the first beam pair link with the wireless communication network.

6. The method of claim 3, further comprising:
establishing, by the first communication device, a first beam pair link with a wireless communication network responsive to receiving a common reference signal that is not specific to the first communication device,
wherein receiving the signaling comprises receiving the signaling subsequent to establishing the first beam pair link with the wireless communication network,
wherein the reference beam direction is the direction of the first beam pair link.

7. The method of claim 2, further comprising:
updating the receive beam pattern or a subset of active antenna beams from the antenna beam directions indicated by the receive beam pattern, responsive to detecting an event.

8. A method comprising:
transmitting, to a first communication device, signaling indicative of an antenna beam direction in which a reference signal may be received by the first communication device;
transmitting, to a second communication device in the wireless communication network, signaling to cause the second communication device to transmit the reference signal in the antenna beam direction,
the first communication device or the second communication device comprising an aerial communication device.

9. The method of claim 8,
wherein the signaling indicative of an antenna beam direction is indicative of a receive beam pattern that indicates antenna beam directions in which one or more reference signals may be received by the first communication device;
wherein transmitting signaling to a second communication device comprises transmitting, to a plurality of second communication devices in the wireless communication network, signaling to cause the second communication devices to transmit the reference signals in the antenna beam directions indicated by the receive beam pattern.

10. The method of claim 9, wherein the antenna beam directions are indicated as relative shifts with respect to a reference beam direction.

11. The method of claim 9, wherein the receive beam pattern and the signaling transmitted to the second communication devices indicate communication resources in which the reference signals are to be transmitted over each of the antenna beam directions.

12. The method of claim 8, wherein the signaling indicative of the antenna beam direction and the signaling to cause the second communication device to transmit the reference signal are transmitted responsive to the first communication device establishing a first beam pair link with the wireless communication network subsequent to receiving a common synchronization reference signal that is not specific to the first communication device.

13. The method of claim 10,
wherein the signaling indicative of the antenna beam direction and the signaling to cause the second communication device to transmit the reference signal are transmitted responsive to the first communication device establishing a first beam pair link with the wireless communication network subsequent to receiving a common synchronization reference signal that is not specific to the first communication device,
wherein the reference beam direction is the direction of the first beam pair link.

14. An apparatus comprising:
a processor coupled with a non-transitory computer readable storage medium storing instructions, wherein when the instructions executed by the processor cause the apparatus to:
receive signaling indicative of an antenna beam direction in which a reference signal may be received by the apparatus;
transmit a message responsive to receiving a reference signal from a second communication device during monitoring of the antenna beam direction indicated by the signaling,
the apparatus or the second communication device comprising an aerial communication device.

15. The apparatus of claim 14, wherein the received signaling is indicative of a receive beam pattern that indicates antenna beam directions in which one or more reference signals may be received by the apparatus.

16. The apparatus of claim 15, wherein the receive beam pattern indicates the antenna beam directions as a sequence of relative shifts with respect to a reference beam direction.

17. The apparatus of claim 15, wherein the receive beam pattern further indicates communication resources that are to be monitored over each of the antenna beam directions.

18. The apparatus of claim 14, wherein when the instructions executed, further cause the apparatus to:
establish a first beam pair link with a wireless communication network responsive to receiving a common synchronization reference signal that is not specific to the apparatus,
wherein receiving the signaling comprises receiving the signaling subsequent to establishing the first beam pair link with the wireless communication network.

19. The apparatus of claim 16, wherein when the instructions executed, further cause the apparatus to:
establish a first beam pair link with a wireless communication network responsive to receiving a common reference signal that is not specific to the apparatus,
wherein receiving the signaling comprises receiving the signaling subsequent to establishing the first beam pair link with the wireless communication network,
wherein the reference beam direction is the direction of the first beam pair link.

20. The apparatus of claim 15, wherein when the instructions executed, further cause the apparatus to:
update the receive beam pattern or a subset of active antenna beams from the antenna beam directions indicated by the receive beam pattern, responsive to detecting an event.
